(19) United States
(12) Patent Application Publication
(10) Pub. No.: US 2012/0162188 A1
(43) Pub. Date: Jun. 28, 2012

(54) SIGNAL PROCESSING DEVICE AND DISPLAY APPARATUS

(75) Inventors: Junichi Yamashita, Tokyo (JP); Katsuhide Uchino, Kanagawa (JP)

(73) Assignee: Sony Corporation, Tokyo (JP)

(21) Appl. No.: 13/287,787

(22) Filed: Nov. 2, 2011

(30) Foreign Application Priority Data
Dec. 24, 2010 (JP) 2010-287755

(51) Int. Cl. G09G 5/00; G09G 3/30

(52) U.S. Cl. 345/212; 345/76

(57) ABSTRACT

A signal processing device includes: a switching element for driving supplying a driving current supplied from a power supply section to a light emitting portion; and a cutoff element cutting off the switching element for driving according to a cutoff signal supplied before a threshold voltage adjusting signal for adjusting a threshold voltage of the switching element for driving is supplied to the switching element for driving from a signal line for supplying the threshold voltage adjusting signal.

### FIELD

The present disclosure relates to a signal processing device and a display apparatus.

### BACKGROUND

Flat panel self-emitting display apparatus employing an organic electroluminescence (EL) device as a light-emitting element are known. An organic EL device is a device utilizing a light-emitting phenomenon which occurs when an electric field is applied to an organic thin film. An organic EL device consumes less power compared to devices such as liquid crystal devices because it is driven at a low applied voltage (e.g., a voltage of 10 V or less). Further, an organic EL device is a self-emitting element which emits light by itself, and the device can therefore be formed with a small thickness because it requires no illuminating member. Further, an organic EL device has a response speed as very high as several and the device can therefore suppress the generation of an after image when displaying a moving image.

The most widely known flat panel self-emission type display apparatus utilizing organic EL devices as pixels are active matrix type display apparatus including a thin-film transistor serving as a driving element and integrally formed with such an EL device at each pixel.

An organic EL device is a current-driven light emitting element, and gray levels of the color of light emitted by the current-driven light emitting element are obtained by controlling the value of a current passed through the element.

An example of the related art includes JP-A-2007-310311 (Patent Document 1).

### SUMMARY

A low-temperature polysilicon TFT substrate may suffer from variation of threshold voltage characteristics and charier mobility characteristics of the transistor. For this reason, a pulsed power supply line may be used to correct a threshold voltage or carrier mobility.

When a pulsed power supply line is used for a current-driven light emitting element, a power supply voltage is supplied to the current-driven light emitting element to cause a transition from an off-state to an on-state. For example, the light-emitting current of current-driven light emitting element is on the order of several μA.

When 1000 pixels having such a current-driven light emitting element are arranged in the horizontal direction, a light-emitting current on the order of several mA is required. A problem has therefore arisen in that a large power supply is required to prevent a power supply voltage from dropping even when a current on the order of several mA flows.

Thus, it is desirable to provide a signal processing device and a display apparatus which can be made compact taking the above-described point into consideration.

An embodiment of the present disclosure is directed to a signal processing device including a switching element for driving and a cutoff element.

The switching element for driving supplies a driving signal supplied from a power supply section to a light emitting element.

The cutoff element cuts off the switching element for driving according to a cutoff voltage supplied before a threshold voltage adjusting signal for adjusting a threshold voltage of the switching element for driving is supplied to the switching element for driving from a signal line for supplying the threshold voltage adjusting signal.

The signal processing device according to the embodiment of the present disclosure can be made compact.

### BRIEF DESCRIPTION OF THE DRAWINGS

FIG. 1 is an illustration of a display apparatus according to a first embodiment of the present disclosure;

FIG. 2 is a diagram of an equivalent circuit of a driving circuit;

FIG. 3 is a schematic sectional view of a part of a light emitting element according to the embodiment of the present disclosure;

FIG. 4 is a timing chart showing operations of the driving circuit;

FIGS. 5A and 5B are circuit diagrams showing operations of the driving circuit;

FIGS. 6A and 6B are circuit diagrams showing operations of the driving circuit;

FIG. 7 is a circuit diagram showing operations of the driving circuit;

FIG. 8 is a timing chart showing other operations of the driving circuit;

FIG. 9 is a timing chart showing other operations of the driving circuit;

FIG. 10 is a circuit diagram of a driving circuit according to a second embodiment of the present disclosure;

FIG. 11 is an illustration of a display apparatus in the form of a flat type module;

FIG. 12 is an illustration of a television set employing a display apparatus according to an embodiment of the present disclosure;

FIGS. 13A and 13B are illustrations of a digital camera employing a display apparatus according to an embodiment of the present disclosure;

FIG. 14 is an illustration of a notebook type personal computer employing display apparatus according to an embodiment of the present disclosure;

FIGS. 15A and 15B are illustrations of a mobile terminal apparatus employing a display apparatus according to an embodiment of the present disclosure;

FIG. 16 is an illustration of a video camera employing a display apparatus according to an embodiment of the present disclosure; and

FIG. 17 is a diagram of another exemplary equivalent circuit of the driving circuit.

### DETAILED DESCRIPTION

Embodiments of the present disclosure will now be described with reference to the drawings.

### 1. First Embodiment

First, a display apparatus having light emitting elements according to a first embodiment of the present disclosure will be briefly described.

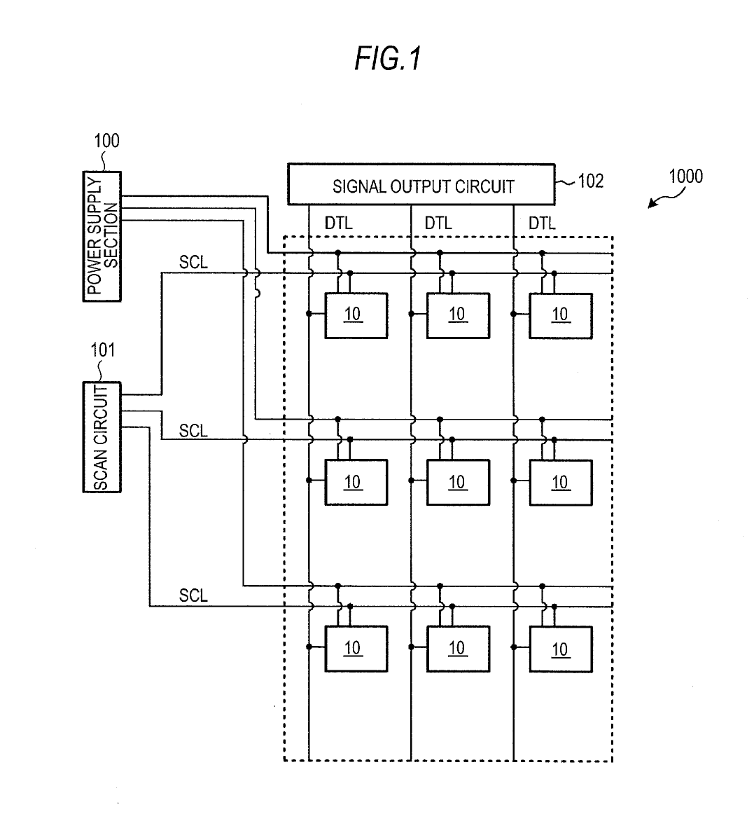

FIG. 1 is a diagram showing a display apparatus according to the embodiment.

A display apparatus 1000 shown in FIG. 1 includes a scan circuit 101, a signal output circuit (horizontal selector) 102, a light emitting element 10, M (M≧1) scan lines SCL, N (N≧1) data lines DTL and a power supply 100.

The display apparatus 1000 shown in FIG. 1 includes a plurality of pixels. Each pixel includes the light emitting element 10 having a light emitting portion and a driving circuit (signal processing device) for driving the light emitting portion.

FIG. 1 shows nine (3×3) light emitting elements 10, and the number of elements is merely an example.

N×M light emitting elements 10 are arranged in the form of a two-dimensional array or matrix having N rows extending in a first direction (a horizontal direction in the present embodiment) and M columns extending in a second direction (which is specifically a direction orthogonal to the first direction or a vertical direction).

Each light emitting element 10 includes an organic electroluminescence light emitting portion. More specifically, each light emitting element 10 is an organic electroluminescence element (organic EL element) having a structure including a driving circuit and an organic electroluminescence light emitting portion (light emitting portion ELP) stacked on the driving circuit in connection therewith.

For example, the light emitting portion may alternatively be an inorganic electroluminescence light emitting portion, an LED portion, or a semiconductor light emitting portion.

The scan circuit 101 performs line sequential scanning of the light emitting elements 10 or sequentially scans the elements on a row-by-row basis. The scan circuit 101 controls timing at which writing data signals supplied from the data lines DTL are written in the light emitting elements 10 on a row-by-row basis. The scan circuit 101 generates potentials to serve as scan signals, i.e., an on-potential at which a data signal is written and an off-potential at which writing of a data signal is stopped. The scan circuit 101 supplies scan signals thus generated to the M scan lines SCL connected to the scan circuit 101 and extending in the first direction in parallel with each other.

The signal output circuit 102 supplies data signals for setting the magnitude of the luminance of light emitted by the light emitting elements 10 to the light emitting elements in each column in accordance with the line sequential scan performed by the scan circuit 101.

The signal output circuit 102 generates data signals in the form of the potentials of video signals for setting the luminance of emitted light (signal potential) and potentials for correcting threshold voltages of driving transistors (switching elements for driving) for driving the light emitting elements 10. The signal output circuit 102 supplies data signals thus generated to N data lines connected to the signal output circuit 102 and extending in a second direction in parallel with each other.

The power supply section 100 generates a power supply voltage for driving the light emitting elements 10 on a row-by-row basis in accordance with the line sequential scanning performed by the scan circuit 101. The power supply section 100 supplies the power supply voltage thus generated to a power supply line.

A detailed description will now be made on a configuration of the driving circuit of the display apparatus 1000 and a method of driving a light emitting section of the apparatus implemented using the driving circuit.

For the sake of convenience, the transistors forming the driving circuit will be described on an assumption that they are n-channel type thin film transistor in principle. However, part of the transistors may be p-channel type TFTs in some cases. There is no particular limitation on the structure of the transistors forming the driving circuit. Although the transistor forming the driving circuit will be described as enhancement type transistors in the following description, the present disclosure is not limited to such transistors. Depression type transistors may alternatively be used. Further, the transistor forming the driving circuit may be single gate type transistors or dual gate type transistors.

The display apparatus 1000 of the present embodiment includes pixels two-dimensionally arranged in the form of (N/3)×M matrix. Each pixel is formed by three sub-pixels (a red light emitting sub-pixel, a green light emitting sub-pixel, and a blue light emitting sub-pixel).

The light emitting elements 10 constituting the pixels are scanned on a line sequential basis. Let us assume that the display frame rate (frames/sec.) of the apparatus is represented by “FR”. That is, (N/3) pixels arranged to form an m-th row (m=1, 2, 3, . . . , M) or, more specifically, light emitting elements constituting N respective sub-pixels are simultaneously driven. In other words, the timing at which the light emitting elements 10 forming each row of pixels emit light or not is controlled by treating the row to which the elements belong as one unit. The process of writing a video signal for each of pixels forming each row of pixels may be a process of writing the video signals for all pixels of the row simultaneously (hereinafter, such a process maybe simply referred to as “simultaneous signal writing process”). Alternatively, a process of writing video signals for respective pixels sequentially (hereinafter, such a process may be simply referred to as “sequential signal writing process”). Either of the signal writing processes may be selected in consideration to the configuration of the driving circuit.

In principle, the driving and operations of a light emitting element will be described by specifying its position as an m-th row and an n-th column (n=1, 2, 3, . . . , N) . Such a light emitting element will be hereinafter called an (n, m)-th light emitting element or an (n, m)-th sub-pixel. Various processes (a threshold voltage correction preparation process, a threshold voltage correcting process, a signal writing process, and a mobility correcting process which will be described later) are carried out until the end of the period of a horizontal scan performed on the light emitting elements arranged on the m-th row (an m-th horizontal scan period). The signal writing process and the mobility correction process are performed within the horizontal scan period of the m-th horizontal scan period. On the contrary, the threshold voltage correcting process and the threshold voltage correction preparation process which precedes the correction process may be performed prior to the m-th horizontal scan period depending on the type of the driving circuit.

After all of the above-mentioned processes are completed, light emitting portions constituting the light emitting elements arranged on the m-th row are made to emit light . The light emitting portions may be made to emit light immediately after all of the above-mentioned processes are completed. The light emitting portions may alternatively be made to emit light when a predetermined period (e.g., a horizontal scan period equivalent to the period of a predetermined number of columns) passes after the completion of the processes. The predetermined period may be appropriately set depending on the specifications of the display apparatus and the configuration of the driving circuit. For the sake of convenience in description, the following description is based on an assumption that the light emitting portions are made to emit light immediately after the various processes are completed. The light emitting portions constituting the light emitting elements arranged on the m-th row continue emitting light until a point in time immediately before the beginning of the horizontal scan period of light-emitting elements arranged on an (m+m′)-th row of pixels. The value of “m′” is determined by the design specification of the display apparatus. That is, the light emitting portions constituting the light emitting elements arranged on the m-th row in a certain frame continue emitting light until the end of the (m+m′−1)-th horizontal scan period. The light emitting portions constituting the light emitting elements arranged on the m-th row continue emitting light in principle from the beginning of the (m+m′)-th horizontal scan period until the signal writing process and the mobility correcting process are completed within the m-th horizontal scan period in the next display frame. Blurring attributable to an after-image can be suppressed to achieve higher quality of moving images by providing periods in a non-emitting state as described above (hereinafter, such periods may be simply referred to as “non-emitting periods”). The emitting state and non-emitting states of sub-pixels (light emitting elements) are not limited to the states described above. The duration of a full horizontal scan period is less than (1/FR)×(1/M) sec. When the value of (m+m′) exceeds the value M, the excess part of the horizontal scan period is processed in the next display frame.

Concerning two source/drain regions of one transistor, the expression “one of source/drain regions” may be used in the sense of the source/drain region connected a power supply section. The expression that “transistor is in an on-state” means the state that a channel is formed between the source/drain regions, regardless of whether a current is flowing from one of the source/drain regions to the other source/drain region. On the other hand, the expression “a transistor is in an off-state” means the state that no channel is formed between the source/drain regions. The expression that “a source/drain region of a transistor is connected to a source/drain region of another transistor” implies that the source/drain region of one transistor and the source/drain region of the other transistor occupy the same area. Further, a source/drain region may be formed from a conductive substance such polysilicon or amorphous silicon doped with an impurity. Alternatively, the region may be formed from a metal, an alloy, or conductive particles, and the region may be also constituted by a multi-layer structure formed by the above-mentioned materials or a layer of an organic material (conductive polymer). In timing charts which will be referred to in the following description, the length (duration) of each period shown along the horizontal axes of the time charts only schematically represents the period, and the proportion between the durations of the periods is not represented by the time charts.

### [Driving Circuit 10a]

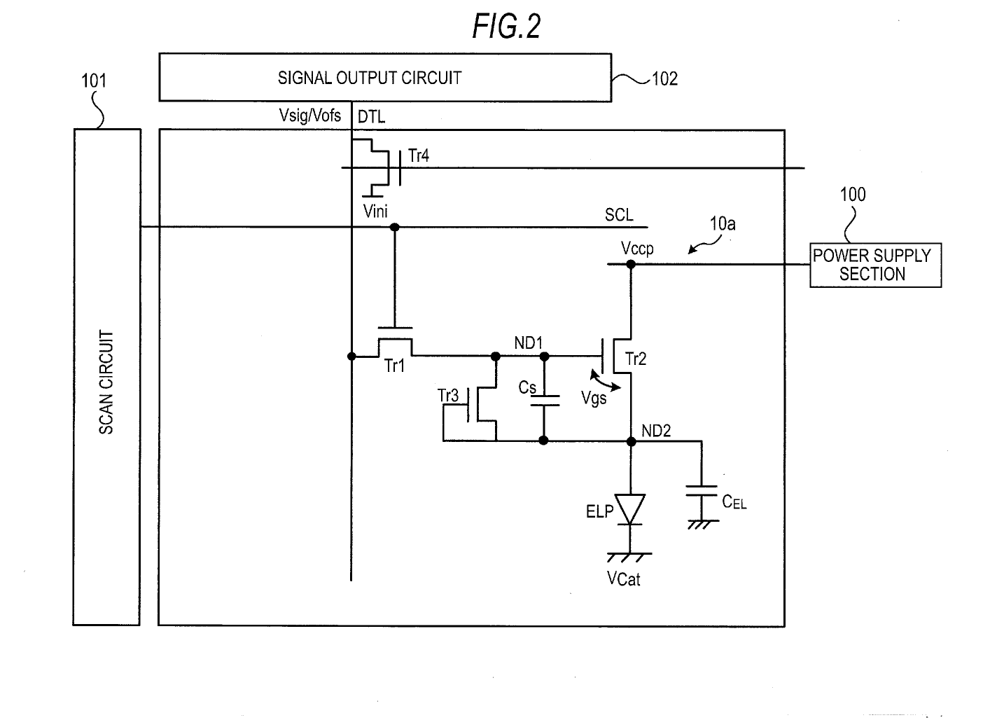

FIG. 2 is a diagram showing an equivalent circuit of the driving circuit.

A driving circuit 10a includes a write transistor (write switching element)Tr1, a driving transistor Tr2, a transistor (cut-off element) Tr3, and a capacity portion Cs.

The write transistor Tr1, the driving transistor Tr2, and the transistor Tr3 are n-channel type transistors.

### [Write Transistor Tr1]

A source terminal of the write transistor Tr1 is connected to a gate terminal of the driving transistor Tr2. A drain terminal of the write transistor Tr1 is connected to the data line DTL. A video signal Vsig for controlling the luminance of a light emitting portion ELP is supplied through the data line DTL to a source/drain region. Various signals or voltages (e.g., a signal for driving pre-charge and various reference voltages) other than the video signal Vsig may be supplied to the source/drain region through the data line DTL. The write transistor Tr1 is turned on/off under control exercised through a scan line SCL connected to a gate electrode of the write transistor Tr1.

### [Driving Transistor Tr2]

A drain terminal of the driving transistor Tr2 is connected to the power supply section 100. A voltage Vccp for causing the light emitting portion ELP to emit light is supplied from the power supply section 100. A source terminal of the driving transistor Tr2 is connected to (1) an anode of the light emitting portion ELP, (2) a source terminal of the transistor Tr3, and (3) one of electrodes of a capacity portion Cs, and the gate terminal constitutes a second node ND2.

The gate terminal of the driving transistor Tr2 is connected to (1) the source terminal of the write transistor Tr1, (2) a drain terminal of the transistor Tr3, and (3) another electrode of the capacity portion Cs, and the gate terminal constitutes a first node ND1.

When the light emitting element is in the emitting state, the driving transistor Tr2 is driven such that a drain current Ids will flow according to Expression (1) shown below.

Ids=k·μ·(Vgs−Vthr)² (1)

In the Expression, μ represents effective mobility; L represents the channel length; W represents the channel width; Vgs represents a potential difference between the gate electrode and the source region; Vthr represents a threshold voltage of the driving transistor Tr2; and k=(½)·(W/L)·Cox, Cox representing (the specific inductive capacity of a gate insulation layer)×(the specific inductive capacity of vacuum)/(the thickness of the gate insulation layer).

When the drain current Ids flows through the light emitting portion ELP, the light emitting portion ELP emits light. Further, the state of emission (luminance) of the light emitting portion ELP is controlled by the value of the drain current Ids.

### [Capacity Portion Cs]

The capacity portion Cs holds a voltage associated with a data signal supplied from the write transistor Tr1. That is, the capacity portion Cs has the function of holding a signal voltage associated with a signal potential written by the write transistor Tr1.

### [Transistor Tr3]

The transistor Tr3 is parallel-connected to the capacity portion Cs.

The drain terminal of the transistor Tr3 is connected to the first node ND1. The source terminal of the transistor is connected to the second node ND2. A gate terminal of the transistor Tr3 is connected to the source terminal of the transistor Tr3. That is, the transistor Tr3 is diode-connected.

A transistor Tr3 having a threshold voltage Vth1 lower than the threshold voltage Vthr of the driving transistor Tr2 may be used as the transistor Tr3.

A description will now be made on the light emitting portion ELP and the transistor Tr4 shown in FIG. 2 which are out of the driving circuit 10a.

### [Light Emitting Portion ELP]

As described above, the anode of the light emitting portion ELP is connected to the source region of the driving transistor Tr2. A voltage VCat is applied to a cathode of the light emitting portion ELP. The capacity of the light emitting portion ELP is represented by C_{EL}. A threshold voltage to be exceeded to cause the light emitting portion ELP to emit light is represented by V_{thr-EL}. The light emitting portion emits light when a voltage equal to or higher than the threshold voltage _{Vthr-EL} is applied between the anode and the cathode of the light emitting portion ELP.

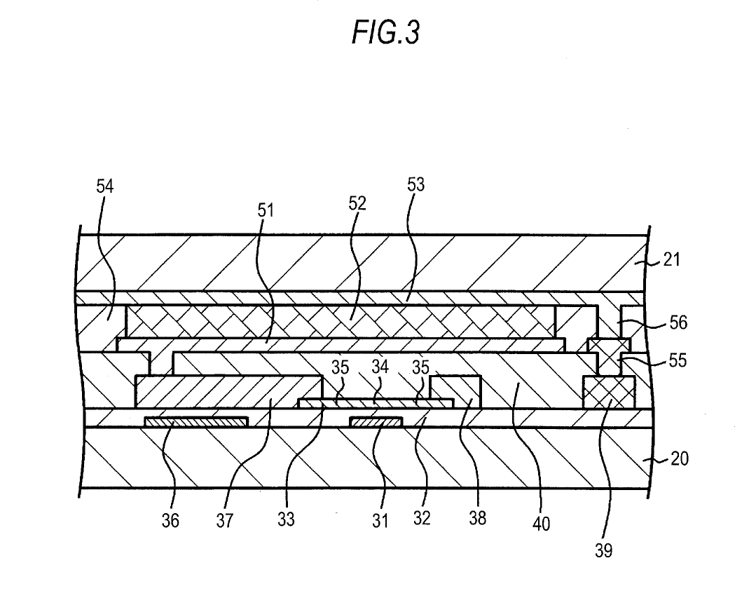

FIG. 3 is a schematic sectional view of a part of the light emitting element according to the present embodiment.

The transistors forming the driving circuit of the light emitting 10 and the capacity portion Cs are formed on a support body 20.

For example, the light emitting portion ELP is formed above the transistors of the driving circuit 10a and the capacity portion Cs with an interlayer insulation layer 40 interposed between them. The other source/drain region of the driving transistor Tr2 is connected to the anode of the light emitting portion ELP through a contact hole. Only the transistor Tr2 is shown in FIG. 3, and the write transistor Tr1 and the transistor Tri are obscured and hidden in the drawing.

The light emitting portion ELP has well-known features or structures such as an anode, a hole transport layer, a light emitting layer, an electron transport layer, and a cathode.

Specifically, the driving transistor Tr2 is formed by a gate electrode 31, a gate insulation layer 32, a semiconductor layer 33, source/drain regions 35 provided in the semiconductor layer 33, and a channel formation region 34 which is a part of the semiconductor layer 33 located between the source/drain regions 35. The capacity portion Cs is formed by an electrode 36, a dielectric layer constituted by an extended part of the gate insulation layer 32, and another electrode 37 (corresponding to the second node ND2 which will be described later). The gate electrode 31, a part of the gate insulation layer 32, and the electrode 36 forming a part of the capacity portion Cs are formed on the support body 20. One of the source/drain regions 35 of the driving transistor Tr2 is connected to a wiring 38, and the other source/drain region 35 is connected to the electrode 37. The driving transistor Tr2 and the capacity portion Cs are covered by the interlayer insulation layer 40, and the light emitting portion ELP formed by the anode 51, the hole transport layer, the light emitting layer, the electron transport layer, and the cathode 53 is provided on the interlayer insulation layer 40. The hole transport layer, the light emitting layer, and the electron transport layer are represented by a layer 52 in FIG. 3. A second interlayer insulation layer 54 is provided on a part of the interlayer insulation layer 40 located in a region outside the light emitting portion ELP. A transparent substrate 21 is disposed on the second interlayer insulation layer 54 and the cathode 53, and light emitted by the light emitting layer travels through the substrate 21 to exit the element. The electrode 37 and the anode 51 are connected through a contact hole provided in the interlayer insulation layer 40. The cathode 53 is connected to a wiring 39 provided on another extended part of the gate insulation layer 32 through contact holes 56 and 55 provided in the second interlayer insulation layer 54 and the interlayer insulation layer 40, respectively.

### [Transistor Tr4]

The transistor Tr4 is connected to the data line DTL. When the transistor Tr4 is turned on, a voltage Vini is supplied to the data line.

Operations of the driving circuit will now be described. Although the description is based on an assumption that the light emitting state of the element starts immediately after various process (a threshold voltage correcting process, a signal writing process, and a mobility correcting process) are completed as described above, the present disclosure is not limited to such an assumption.

Although the following description is based on voltage and potential values as defined below, the values are only shown for the purpose of description. The present disclosure is not limited to such values.

Vsig: a video signal at a voltage in the range from 0 to 10 V for controlling the luminance of the light emitting portion ELP

Vccp: a voltage of 6 V output by the power supply section 100

Vofs: a voltage of 0 V for initializing the potential at the gate electrode of the driving transistor Tr2 (the potential at the first node ND1)

Vini: a voltage of −6 V Vofs −Vthr or less

VSS: a voltage of −10 V for initializing the potential at the source region of the driving transistor Tr2 (the potential at the second node ND2)

Vthr: a threshold voltage of 3 V set for the driving transistor Tr2

Vth1: a threshold voltage of 2 V set for the transistor Tr3

Vcat: a voltage of 0 V applied to the cathode of the light emitting portion ELP

V_{thr-EL}: a threshold voltage of 3 V set for the light emitting portion ELP

For example, a method of driving the light emitting portion ELP of the driving circuit 10a includes the steps of:

(a) performing a threshold voltage correction preparation process wherein the first node initializing voltage and the second node initializing voltage to the first node ND1 and the second node ND2, respectively, such that a potential difference between the first node ND1 and the second node ND2 will exceed the threshold voltage of the transistor Tr3 and such that a potential difference between the second node ND2 and the cathode of the light emitting portion ELP will not exceed the threshold voltage of the light emitting portion ELP;

(b) thereafter performing a threshold voltage correcting process wherein the potential at the first node ND1 is rewritten into a threshold voltage adjusting signal to change the potential at the second node ND2 toward a potential equivalent to the potential at the first node ND1 minus the threshold voltage of the driving transistor Tr2;

(c) thereafter performing a signal writing process wherein a video signal is applied from the data line DTL to the first node ND1 through the write transistor Tr1 which has been turned on by a signal from the scan line SCL; and

(d) thereafter turning the write transistor Tr1 off with a signal from the scan line SCL to put the first node ND1 in a floating state and driving the light emitting portion ELP by causing a current according to the value of the potential difference between the first node ND1 and the second node ND2 to flow from the power supply section 100 to the light emitting portion ELP through the driving transistor Tr2.

As described above, a threshold voltage correcting process is performed at the step (b) to change the potential at the second node ND2 toward a potential equivalent to the potential at the first node ND1 minus the threshold voltage of the driving transistor Tr2. More specifically, in order to change the potential at the second node ND2 toward a potential equivalent to the potential at the first node ND1 minus the threshold voltage of the driving transistor Tr2, a voltage in the excess of a voltage equivalent to the potential at the second node ND2 plus the threshold voltage of the driving transistor Tr2 obtained at the step (a) to one of the source/drain regions of the driving transistor Tr2. Qualitatively speaking, at the threshold voltage correcting process, the potential difference between the first node ND1 and the second node ND2 (or a potential difference between the gate electrode and the source region of the driving transistor Tr2) approaches the threshold voltage of the driving transistor Tr2 at a degree which depends on the duration of the threshold voltage correcting process. Therefore, in a configuration in which the duration of the threshold correcting process is kept sufficiently long, the potential at the second node ND2 reaches the potential at the first node ND1 minus the threshold voltage of the driving transistor Tr2. The potential difference between the first node ND1 and the second node ND2 reaches the threshold voltage of the driving transistor Tr2, and the driving transistor Tr2 is turned off. On the contrary, in a configuration in which it is inevitable to set the duration of the threshold voltage correcting process short, the potential difference between the first node ND1 and the second node ND2 may be greater than the threshold voltage of the driving transistor Tr2, and the driving transistor Tr2 may therefore be not turned off. It is not essential that the driving transistor Tr2 is turned off as a result of the threshold voltage correcting process.

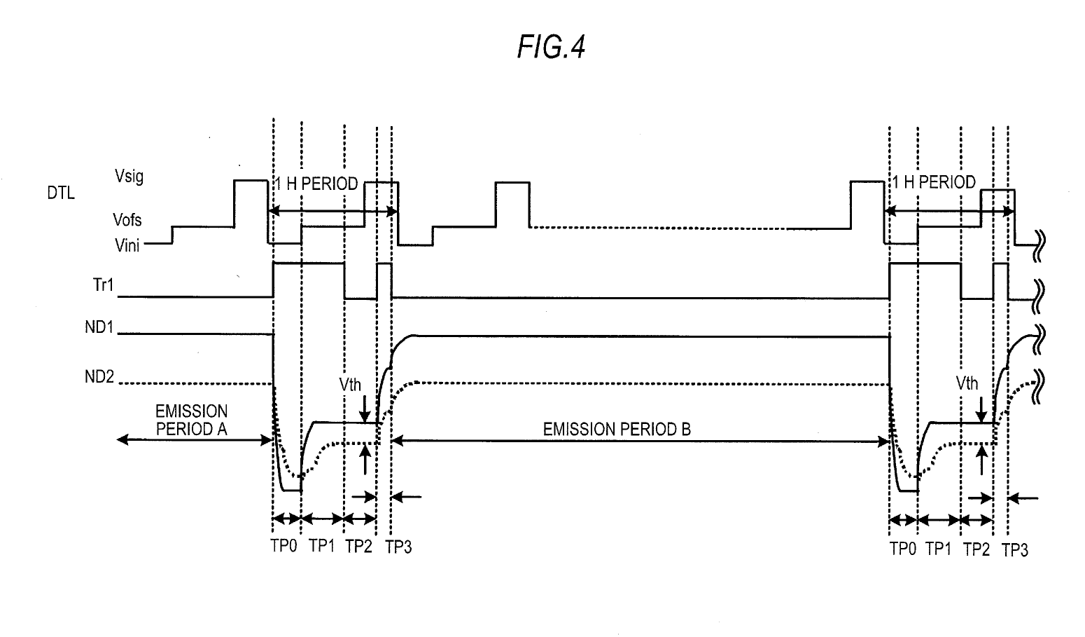

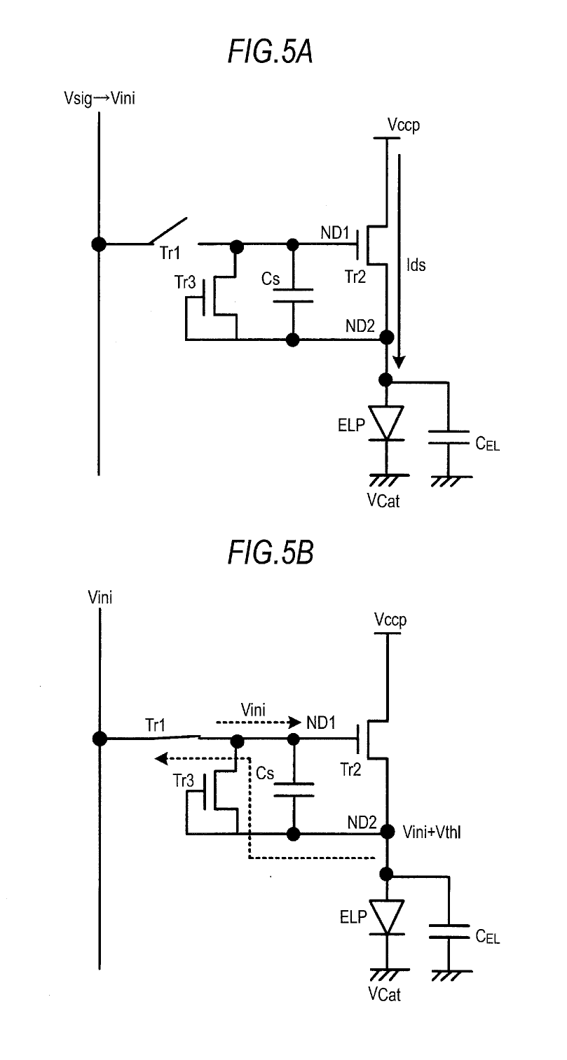

FIG. 4 is a timing chart showing operations of the driving circuit, and FIGS. 5A, 5B, 6A, 6B, and 7 are circuit diagrams showing operations of the driving circuit in various periods.

The lengths of horizontal lines representing the various periods in FIG. 4 are only schematically shown, and the actual proportion between the durations of the periods is not limited to what is illustrated.

Various voltage values in FIG. 4 are represented as relative values, and no absolute voltage value is represented by the figure.

In FIGS. 5A, 5B, 6A, 6B, and 7, the write transistor Tr1 is illustrated in the form of a switch for better understanding of the description.

### [Emission Period A] (see FIG. 4 and FIG. 5A)

For example, the term “emission period A” may represent the period of emission in the frame displayed before the present frame. During such an emission period A, the drain current Ids flows through the light emitting portion ELP. The write transistor Tr1 and the transistor Tri are in the off-state, and the driving transistor Tr2 is in the on-state.

Within one frame (which is represented as “one horizontal (H) period” in FIG. 4), the potential on the data line DTL changes from the voltage Vini to the voltage Vofs and then changes from the voltage Vofs to the voltage Vsig.

Periods TP0 to TP2 shown in FIG. 4 are the periods of operations performed until a point in time immediately before the next signal writing process. During the periods TP0 to TP2, an (n, m)-th light emitting element 10 is in the non-emitting state in principle. As shown in FIG. 4, periods TP1 to TP2 are included in an m-th horizontal scan period of the operation of the driving circuit 10a as well as a period TP3. For the sake of convenience, the description will be continued on an assumption that the beginning of the period TP1 and the end of the period TP3 corresponds to the beginning and the end of the m-th horizontal scan period.

Each of the periods TP0 to TP2 will now be described. The duration of each of the periods TP1 to TP3 may be appropriately set depending on the design of the display apparatus.

### [Period TP0] (see FIG. 4 and FIG. 5B)

At the beginning of the period TP0, the potential on the data line DTL is the voltage Vini. The write transistor Tr1 is turned on by setting the scan line SCL at a high level . Thus, the m-th horizontal scan period in the presently displayed frame begins. The threshold voltage correction preparation process for enabling the threshold voltage correcting process is performed in the period TP0. At the beginning of the period TP0, since the light emitting portion ELP is in the emitting state, the potential at the anode of the light emitting portion ELP is 6 V which is higher than the voltage Vini. In this state, the transistor Tr3 is turned on to discharge a source voltage of the driving transistor Tr2. Meanwhile, since the voltage Vini is supplied to the gate terminal of the driving transistor Tr2, the driving transistor Tr2 is turned off. Since the supply of the drain current Ids to the light emitting portion ELP stops as the driving transistor Tr2 is turned off, the light emitting portion ELP enters the non-emitting state.

Thereafter, the potential at the node ND2 continues decreasing until the transistor Tr3 is turned off. When the potential at the node ND2 reaches a value equivalent to the voltage Vini plus the voltage Vth1, the transistor Tr3 is turned off, and the voltage stops decreasing.

At this time, the gate-source potential difference Vgs of the driving transistor Tr2 equals −Vth1 (=Vini−(Vini+Vth1)). That is, the potential difference Vgs of the driving transistor Tr2 falls below the threshold voltage Vthr of the transistor Tr2 to reach a cutoff point. That is, even if the drain voltage of the driving transistor is at the voltage Vccp at which the light emitting element 10 can be made to emit light, no current flows through the driving transistor Tr2, and the threshold voltage of the driving transistor Tr2 is initialized in preparation for correction. As a result, the potential at the first node ND1 becomes −6 V which is equal to the voltage Vini. The potential at the second node ND2 drops to, for example, about −4 V.

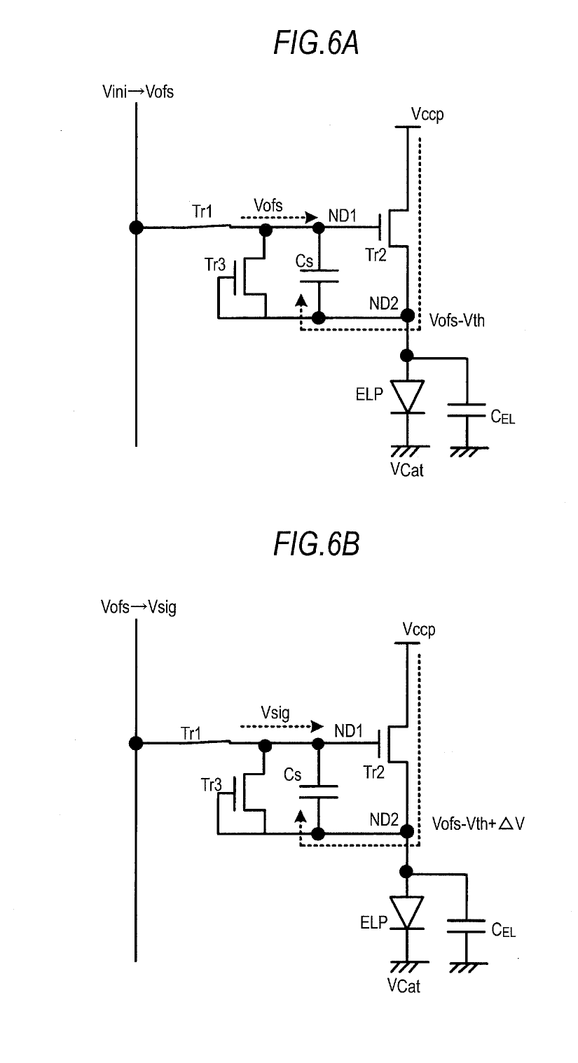

### [Period TP1] (see FIG. 4 and FIG. 6A)

Next, the threshold voltage correcting process is performed. Specifically, the signal output circuit 102 increases the potential on the data line DTL from the voltage Vini to the voltage Vofs with the write transistor Tr1 kept in the on-state. When the potential on the data line DTL is increased to the voltage Vofs, the potential difference Vgs of the driving transistor Tr2 temporarily becomes greater than the threshold voltage Vthr. Thus, the driving transistor Tr2 is turned on, and a current flows through the driving transistor Tr2 to initiate the threshold voltage correcting process. Specifically, the potential at the second node ND2 in the floating state approaches the voltage Vofs minus the voltage Vthr, i.e., −3 V and finally equals the voltage Vofs minus the voltage Vthr. Thus, a voltage equivalent to the threshold voltage Vthr of the driving transistor Tr2 is written in the capacity portion Cs.

At this time, the light emitting portion ELP will not emit light when if Expression (2) shown below is true or when the potentials are selected or determined such that Expression 2 holds true.

(Vofs−Vthr)<(V_{thr-EL}+Vcat) (2)

In the period TP1, the potential at the second node ND2 finally becomes the voltage Vofs minus the voltage Vthr. That is, the potential at the second node ND2 is determined depending on only the threshold voltage Vthr of the driving transistor Tr2 and the voltage Vofs for initializing the gate electrode of the driving transistor Tr2. The potential is determined regardless of the threshold voltage V_{thr-EL} of the light emitting portion ELP.

### [Period TP2] (see FIG. 4)

After the period TP1 ends, the write transistor Tr1 is turned off. Then, the video signal Vsig for controlling the luminance of the light emitting portion ELP is applied as the potential on the data line DTL.

### [Period TP3] (see FIG. 4 and FIG. 6B)

Next, a signal writing process is performed on the driving transistor Tr2, and the potential at the source region of the driving transistor Tr2 (the second node ND2) is corrected based on the magnitude of mobility μ of the driving transistor Tr2 (a mobility correcting process). Specifically, after the potential on the data line DTL becomes the video signal Vsig for controlling the luminance of the light emitting portion ELP, the write transistor Tr1 which has been turned off in the period PT2 is turned on. As a result, the potential at the first node ND1 increases to the voltage Vsig, and the driving transistor Tr2 is turned on.

The potential difference Vgs between the gate electrode and the source electrode of the driving transistor Tr2 is given by Expression (3).

Vgs≈Vsig−(Vofs−Vthr)−ΔV (3)

In the Expression, ΔV represents the amount of a potential increase at the source region of the driving transistor Tr2.

Since the voltage Vccp is applied from the power supply section 100 to the drain region of the driving transistor Tr2, the potential at the source region of the driving transistor Tr2 increases. The duration of the period TP3 may be determined in advance as a design value when the display apparatus is designed such that the potential at the second node ND2 equals the voltage Vofs minus the voltage Vthr plus the amount ΔV.

When the mobility μ of the driving transistor Tr2 still has a great value in the period TP3, the increase ΔV of the potential at the source region of the driving transistor Tr2 is great. When the mobility μ of the driving transistor Tr2 has a small value in the period, the increase ΔV of the potential at the source region of the driving transistor Tr2 is small.

The threshold voltage correcting process, the signal writing process, and the mobility correcting process are completed as described above.

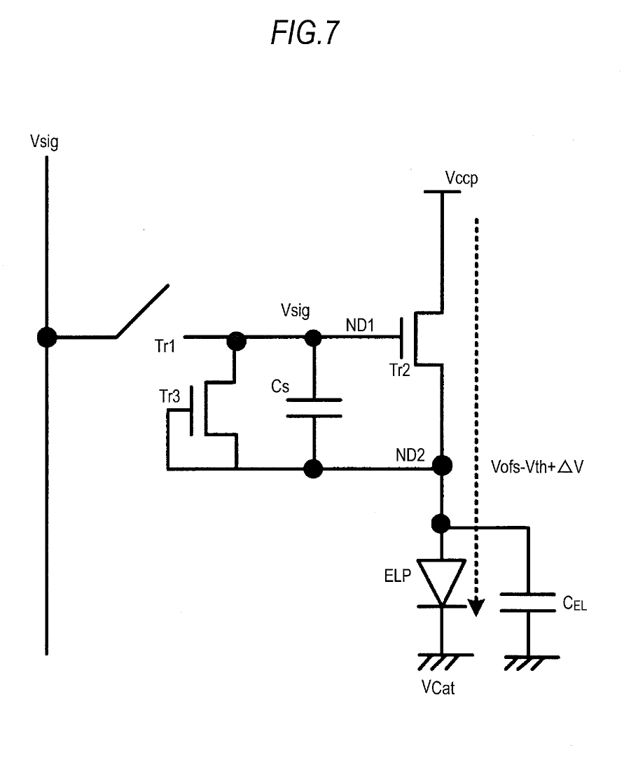

### [Emission Period B] (see FIG. 4 and FIG. 7)

The write transistor Tr1 is turned off by setting the scan line SCL at a low level, and the first node ND1 (the gate electrode of the driving transistor Tr2) is put in a floating state. Since the potential at the second node ND2 increases beyond the voltage V_{thr-EL} plus the voltage Vcat, the light emitting portion ELP starts emitting light. The current which flows through the light emitting portion ELP can be given by Expression (4) shown below.

Ids=k·μ·(Vsig−Vofs−ΔV)² (4)

As will be apparent from Expression (4), the drain current Ids flowing through the light emitting portion ELP does not depend on the threshold voltage V_{thr-EL} of the light emitting portion ELP and the threshold voltage Vₜₕᵣ of the driving transistor Tr2. That is the amount of light emitted by the light emitting portion ELP (luminance) is not affected by the threshold voltage V_{thr-EL} of the light emitting portion ELP and the threshold voltage Vₜₕᵣ of the driving transistor Tr2. In addition, variation of the drain current Ids attributable to variation of the mobility μ of the driving transistor Tr2 can be suppressed.

The light emitting state of the light emitting portion ELP continues through the (m+m′−1)-th horizontal scan period up to a point in time corresponding to the end of the emission period.

During the period TP1 through the emittion period B, the gate-source potential difference Vgs of the driving transistor Tr2 is greater than the threshold voltage Vthr. Therefore, the transistor Tr3 is in the cut-off state in which no current flows, and the transistor has no influence on the potential difference Vgs of the driving transistor Tr2.

The light emitting operation of the light emitting element 10 forming part of the (n, m)-th sub-pixel is completed as thus described.

In the flow of operations shown in FIG. 4, the threshold voltage correcting process is performed after the threshold voltage correction preparation process is finished with no time interval left between the processes. The present disclosure is not limited to such an embodiment, and the threshold voltage correcting is process may be started when predetermined time has passed since the end of the threshold voltage correction preparation process.

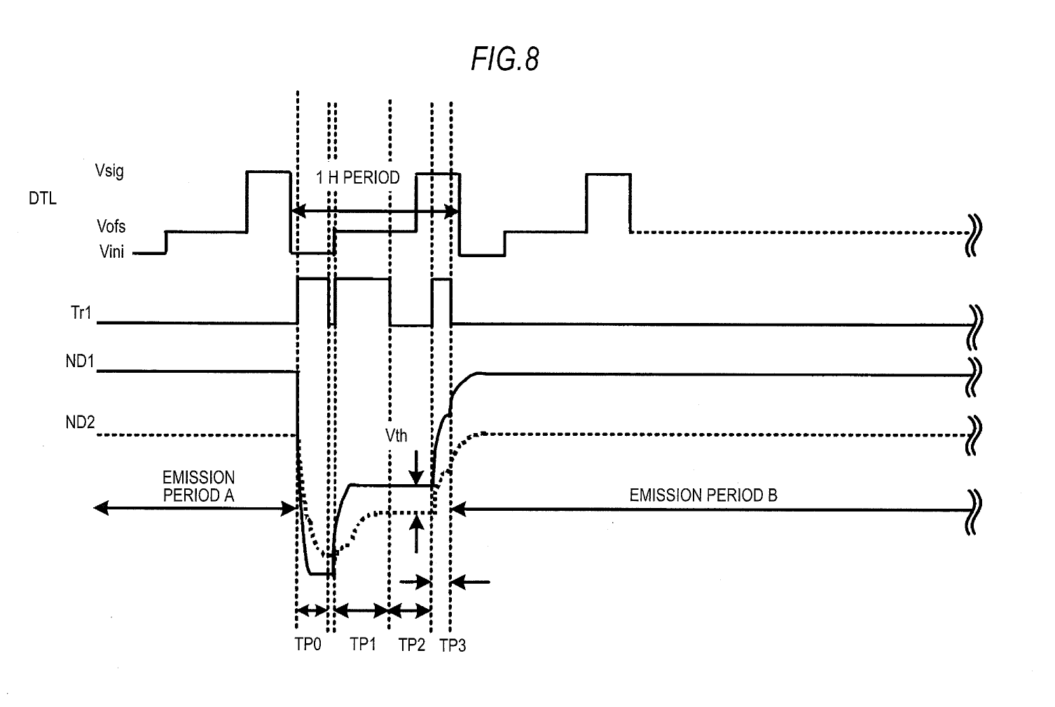

FIG. 8 is a timing chart showing another exemplary flow of operations of the driving circuit.

The write transistor Tr1 may be temporarily turned off after the end of the period TP0 ends, and the write transistor Tr1 may be turned on when the period TP1 begins.

A quenching operation may be performed by turning the write transistor Tr1 on and off prior to the threshold voltage correction preparation process.

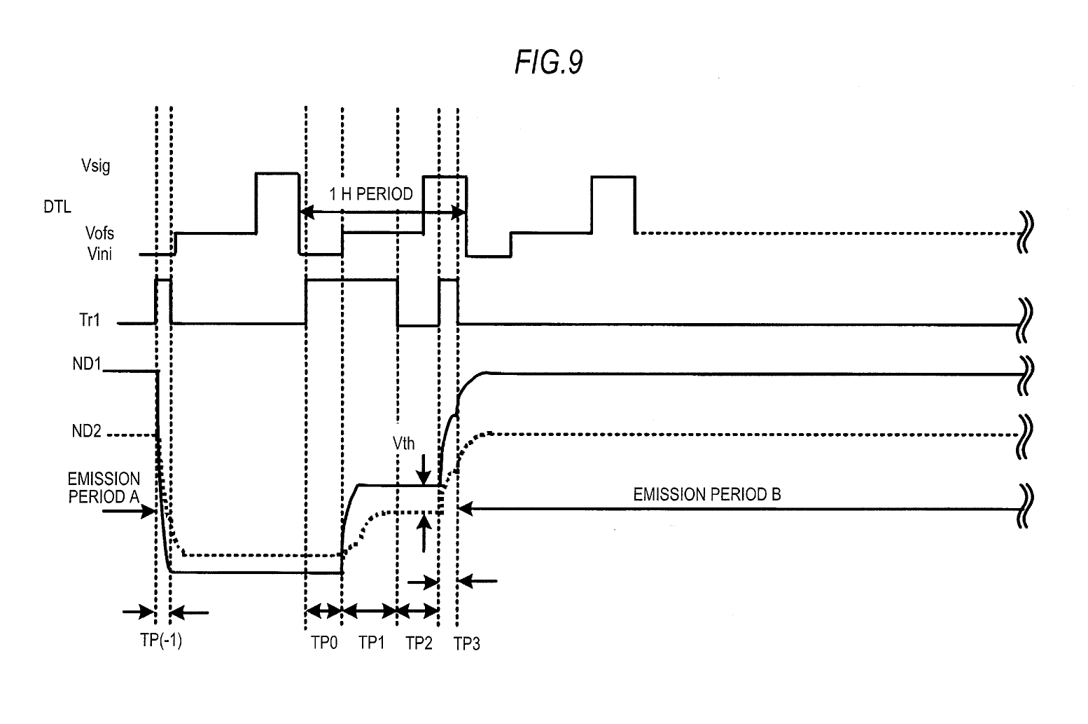

FIG. 9 is a timing chart showing still another exemplary flow of operations of the driving circuit.

In the timing chart shown in FIG. 9, the light emitting portion ELP is quenched in the frame preceding the display frame to which the period TP0 belongs.

Specifically, a period TP(−1) is provided to allow the write transistor Tr1 to be turned on and off when the potential on the data line DTL in the frame preceding the frame to which the period TP0 belongs is the voltage Vini. The write transistor Tr1 is turned on again in the presently displayed frame to start the threshold voltage correction preparation process.

As thus described, the light-emitting portion ELP of the display apparatus 1000 according to the first embodiment of the present disclosure can be quenched only by turning the write transistor Tr1 on in the light emitting state of the apparatus when the potential on the data line DTL is the voltage Vini. Quenching time can be increased by turning the write transistor Tr1 on in the frame preceding the display frame to which the period TP0 belongs, whereby high moving picture characteristics can be achieved.

The present disclosure is not limited to quenching in the preceding frame, and the quenching time may alternatively be increased by turning the write transistor Tr1 on in the frame preceding the present frame by two or more places in the sequence of frames.

Further, the threshold voltage correction preparation process and the threshold voltage correcting process may be performed using split pulses.

As described above, in the display apparatus 1000, the transistor Tr3 is diode-connected between the gate and the source of the driving transistor Tr2, and the potential on the data line DTL is set at the voltage Vini in the period TP0. Thus, the source voltage of the driving transistor Tr2 can be decreased with the drain voltage of the driving transistor Tr2 kept at the fixed voltage Vccp. As a result, the function of converting the power supply voltage into pulses to enable the emitting operation and the non-emitting operation of the light-emitting portion ELP can be omitted, which allows the power supply section 100 to be made compact. The display apparatus 1000 can therefore be made compact.

The following advantages can be provided by omitting the function of converting the power supply voltage into pulses.

According the related art, when there are overlaps between power supply lines and data lines DTL, measures taken to cope with the problem include increasing the resistance of data lines DTL in the overlapping parts.

However, an increase in the resistance of data lines DTL hinders efforts toward an increase in the transfer rate of signals passing through the data lines DTL. When power supply lines and data lines are provided in different layers, the number of steps for manufacturing a display apparatus increases.

Since the function of converting a power supply voltage into pulses is omitted, the display apparatus 1000 can be easily provided with a configuration in which data lines DTL and power supply lines are prevented from overlapping each other, for example, by disposing signal lines in parallel with the data lines DTL. Any reduction in signal wiring speed can be suppressed in a configuration in which data lines DTL and power supply lines do not overlap because there is no need for increasing the resistance of the data lines DTL.

Although the description of the embodiment of the present disclosure has addressed a configuration of a driving circuit in which a driving current is supplied to a light emitting portion ELP by a write transistor Tr1, a driving transistor Tr2, a transistor Tr3, and a capacity portion Cs, the present disclosure is not limited to such a configuration. The present disclosure may be applied to a driving circuit including other transistors for controlling the emission of the light emitting portion ELP in addition to the above-described elements.

### Second Embodiment

A display apparatus according to a second embodiment of the present disclosure will now be described.

The following description will focus on differences between the display apparatus according to the second embodiment and the apparatus according to the first embodiment, and items which are similar between the first and second embodiments will be omitted from the description.

The display apparatus of the second embodiment is different from the first embodiment in the configuration of the driving circuits.

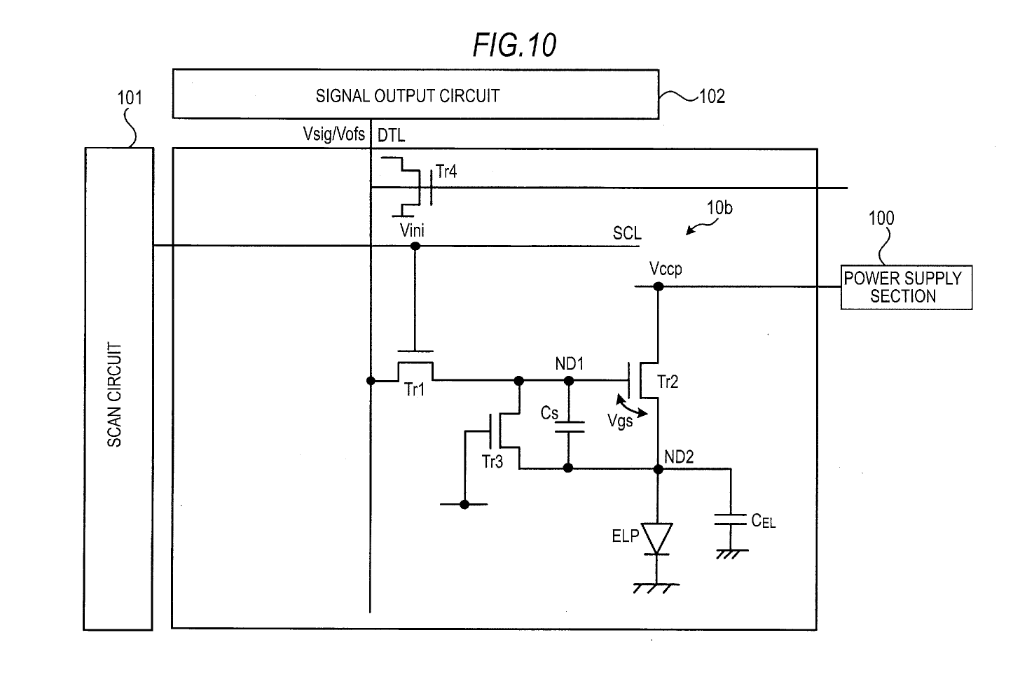

FIG. 10 is a circuit diagram of a driving circuit 10b according to the second embodiment.

In the driving circuit 10b, a gate terminal of a transistor Tr3 is connected to a power supply which outputs a fixed voltage. Thus, a potential at the gate terminal of the transistor Tr3 is set at a fixed potential.

The fixed voltage is set at such a value that the transistor is turned on only in a period TP0 (e.g., −4 V). Thus, the transistor Tr3 is turned on only when a threshold voltage correction preparation process is performed.

The display apparatus 1000 according to the second embodiment provides advantages similar to those of the display apparatus 1000 according to the first embodiment.

The display apparatus 1000 according to the second embodiment is further advantageous in that the transistor Tr3 may be a depression type in terms of threshold characteristics.

Several signal processing devices and display apparatus according to the present disclosure have been described above based on the illustrated embodiments. However, the present disclosure is not limited to such embodiments, and the configuration of each part of the embodiments may be replaced with an arbitrary configuration which provides similar functions. Other features or manufacturing steps may be arbitrarily added to those described in the present disclosure.

The present disclosure may be implemented by combining two or more features of the above-described embodiments arbitrarily.

The display apparatus 1000 described above as first and second embodiments of the present disclosure (hereinafter simply referred to as “display apparatus 1000 may be apparatus in the form of flat type modules.

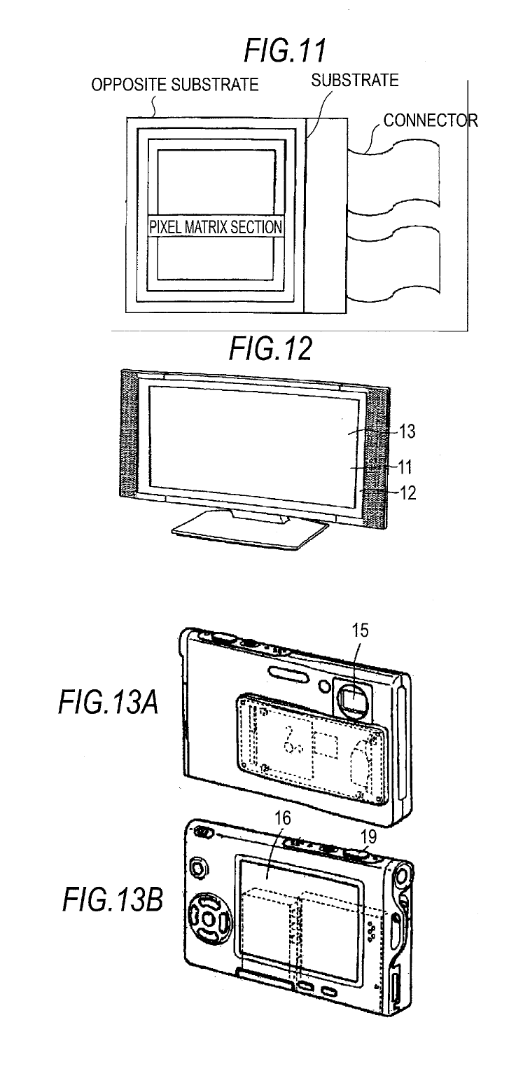

FIG. 11 is an illustration of a display apparatus in the form of a flat type module.

For example, a pixel array section (pixel matrix section) is provided by integrating pixels each having a liquid crystal element, thin film transistors, a thin film capacity, and a light-receiving element on an insulated substrate.

An adhesive is applied to the substrate so as to surround the pixel array section with the adhesive, and an opposite substrate made of glass or the like is attached to the substrate to form a display module. Color filters, a protective film, and a shield film may be provided on the +transparent substrate as occasion demands. For example, the display module may be provided with an FPC (flexible printed circuit) as a connector to be inputting and outputting signals to and from the pixel array section.

Display apparatus 1000 as described above are in the form of flat panels, and the panels can be used as displays of various electronic apparatus in all fields which display video signals input thereto or generated therein as images, such apparatus including, for example, digital cameras, notebook type personal computers, mobile phones, and video cameras. Electronic apparatus employing such a display will be described below by way of example.

FIG. 12 is an illustration of a television set employing a display apparatus according to an embodiment of the present disclosure.

The television set shown in FIG. 12 includes an image display screen 11 having a front panel 12 and a filter glass 13. A display apparatus 1000 is used as the image display screen 11.

FIGS. 13A and 13B are illustrations of a digital camera employing a display apparatus according to an embodiment of the present disclosure. FIG. 13A is an illustration of a front side of the digital camera, and FIG. 13B is an illustration of a rear side of the digital camera.

The digital camera shown in FIGS. 13A and 13B includes an imaging lens, a light emitting section 15 serving as a flashlight, a display section 16, control switches, menu switches, and a shutter 19. A display apparatus 1000 is used as the display section 16.

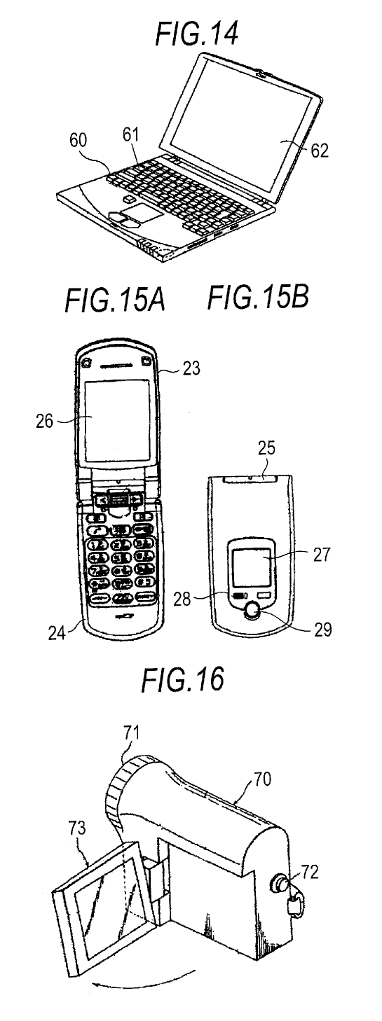

FIG. 14 is an illustration of a notebook type personal computer employing a display apparatus according to an embodiment of the present disclosure.

The notebook type personal computer shown in FIG. 14 includes a keyboard 61 provided on a main body 60 thereof and operated to input characters and the like and a display section 62 for displaying images provided on a main body cover. A display apparatus 1000 is used as the display section 62.

FIGS. 15A and 15B are illustrations of a mobile terminal apparatus employing display apparatus according to an embodiment of the present disclosure. FIG. 15A shows the mobile terminal apparatus in an open state, and FIG. 15B shows the mobile terminal in a lapped (closed) state.

The mobile terminal apparatus includes a top housing 23, a bottom housing 24, a connecting section (a hinge section) 25, a display 26, a sub-display 27, a picture light 28, and a camera 29. Display apparatus 1000 are used as the display 26 and the sub-display 27.

FIG. 16 is an illustration of a video camera employing a display apparatus according to an embodiment of the present disclosure.

The video camera includes a main body 70, a lens 71 for imaging an object provided on a front side of the apparatus, a switch 72 for starting and stopping imaging, and a monitor 73. A display apparatus 1000 is used as the monitor 73.

In FIG. 2, only a capacity C_{EL} of the light emitting portion ELP is shown between the second node ND2 and the voltage VCat. The present disclosure is not limited to such a configuration, and a capacity C_{sub} similar to the capacity portion Cs may be parallel-connected in addition to the capacity C_{EL} of the light emitting portion ELP.

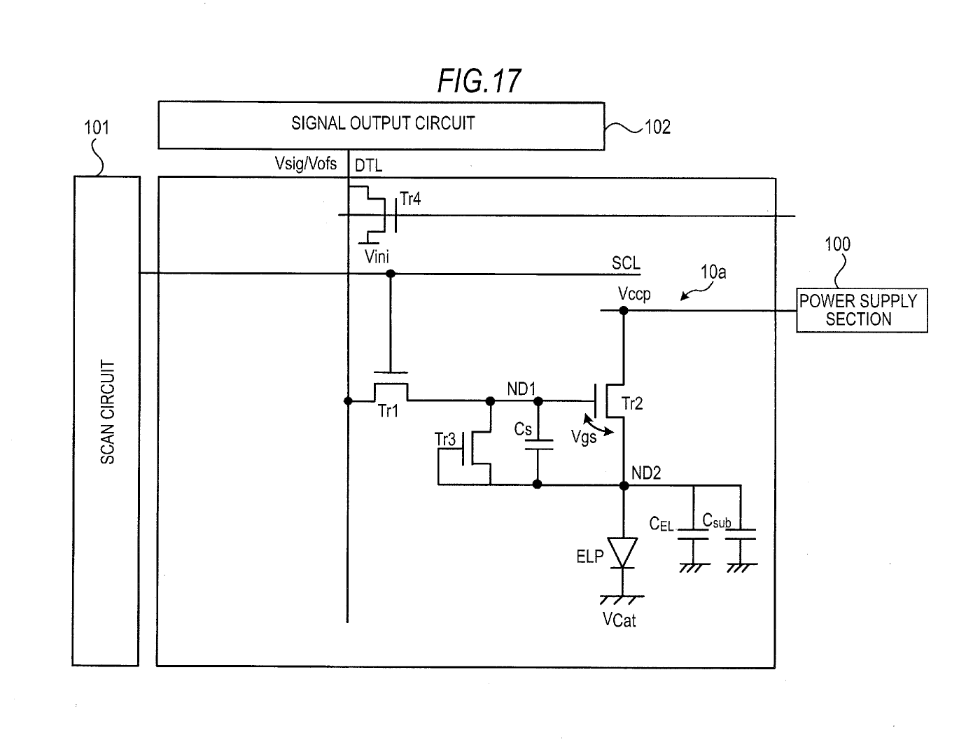

FIG. 17 is another exemplary equivalent circuit of the driving circuit.

The present disclosure contains subject matter related to that disclosed in Japanese Priority Patent Application JP 2010-287755 filed in the Japan Patent Office on Dec. 24, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing device comprising:
a switching element for driving supplying a driving current supplied from a power supply section to a light emitting portion; and
a cutoff element cutting off the switching element for driving according to a cutoff signal supplied before a threshold voltage adjusting signal for adjusting a threshold voltage of the switching element for driving is supplied to the switching element for driving from a signal line for supplying the threshold voltage adjusting signal.

2. A signal processing device according to claim 1, wherein a voltage value of the cutoff signal is set smaller than a value obtained by subtracting the threshold voltage from a voltage value of the threshold voltage adjusting signal.

3. A signal processing device according to claim 1, wherein the cutoff element has a diode function for supplying a voltage at a point where the switching element for driving is connected to the light emitting portion to the signal line.

4. A signal processing device according to claim 3, wherein the cutoff element is a diode-connected transistor.

5. A signal processing device according to claim 3, wherein the cutoff element is a transistor whose gate is set at a fixed potential.

6. A signal processing device according to claim 1, further comprising
a write switching element provided between the signal line and the switching element for driving, wherein
he cutoff signal and the threshold voltage adjusting signal are supplied for each frame; and
the write switching element is turned on when the cutoff signal for the preceding or earlier frame is being supplied to supply the cutoff signal to the switching element for driving and turned off before the threshold voltage adjusting signal for the preceding frame is supplied.

7. A display apparatus comprising:
a light emitting portion;
a driving transistor; and
a switching transistor, wherein:
the driving transistor supplies a current to the light emitting portion;
the switching transistor is diode-connected and connected between a gate and source of the driving transistor; and
the light emitting portion stops emitting light when a voltage at the source of the driving transistor is discharged through the switching transistor.

8. A display apparatus according to claim 7, further comprising:
a signal line supplying a video signal to the driving transistor; and
a sampling transistor connected between the signal line and the switching transistor, wherein
the light emitting portion stops emitting light when the voltage at the source of the driving transistor is discharged through the switching transistor and the signal line.

9. A display apparatus comprising:
a signal processing device including a switching element for driving supplying a driving current supplied from a power supply section to a light emitting portion and a cutoff element cutting off the switching element for driving according to a cutoff signal supplied before a threshold voltage adjusting signal for adjusting a threshold voltage of the switching element for driving is supplied to the switching element for driving from a signal line for supplying the threshold voltage adjusting signal; and
a plurality of pixels having the light emitting portion and emitting light with luminance according to the driving current when the driving current is supplied to the light emitting portion.
